(19) United States
(12) Patent Application Publication
(10) Pub. No.: US 2021/0133931 A1
(43) Pub. Date: May 6, 2021

(54) METHOD AND APPARATUS FOR EDITING IMAGE

(71) Applicant: LG ELECTRONICS INC., Seoul (KR)

(72) Inventors: Woon Chae LEE, Seoul (KR); Won Su CHOI, Gwangmyeong-si (KR); Seon Hui Sunny KIM, Seoul (KR); Min Ho LEE, Seoul (KR)

(73) Assignee: LG ELECTRONICS INC., Seoul (KR)

(21) Appl. No.: 16/736,625

(22) Filed: Jan. 7, 2020

(30) Foreign Application Priority Data
Nov. 6, 2019 (KR) 10-2019-0141167

(51) Int. Cl. G06T 5/00

(52) U.S. Cl. CPC G06T 5/002; G06T 2207/20081; G06T 2207/20084; G06T 5/001

(57) ABSTRACT

A method and an apparatus for editing an image are provided. The method for editing an image includes editing an image through filter application, storing filter information, retraining a deep neural network model based on the filter information, and outputting the filter information using the deep neural network model. According to the present disclosure, image editing based on image analysis using an artificial intelligence (AI) model through a 5G network is possible.

### CROSS-REFERENCE TO RELATED APPLICATION

This present application claims the benefit of priority to Korean Patent Application No. 10-2019-0141167, entitled “METHOD AND APPARATUS FOR EDITING IMAGE,” filed on Nov. 6, 2019, in the Korean Intellectual Property Office, the entire disclosure of which is incorporated herein by reference.

### BACKGROUND

### 1. Technical Field

The present disclosure relates to a method and an apparatus for editing an image, and more specifically, to a method that includes extracting information on a filter based on image analysis and editing an image by using the extracted filter information, and an apparatus therefor.

### 2. Description of Related Art

An advantage of digital cameras is that users are enabled to edit a captured image through processing of the image. Digital image editing includes removing noise generated in the photographing process or adjusting brightness, and also reducing a difference in color representation between the digital camera and human eyes.

As one related art, an image processing apparatus is disclosed in the KR laid-open gazette. According to this related art, an image can be processed through discrete cosine transform (DCT) and inverse DCT processes.

As another related art, a filtering method is disclosed in the KR laid-open gazette. According to this related art, a method of filtering before converting an analog image signal into a digital image signal is disclosed.

However, the present disclosure relates to a method and an apparatus for editing an image, in which the method includes removing noise of digital images and adjusting brightness and correcting colors, and more specifically, the method includes collecting information on filters used in image processing, and editing an image according to the filter pattern which is mainly used by a user, which is extracted based on the collected filter information. Thus, the present disclosure is distinguished from the aforementioned related arts.

### SUMMARY OF THE INVENTION

An aspect of the present disclosure is to provide a method for editing an image according to filter patterns by using an artificial intelligence model which is retrained by a device based on information on a filter applied by a user or by an artificial intelligence model.

Another aspect of the present disclosure is to provide a method for editing an image which is suitable for a filter usage pattern of a user by applying a weighted value to a filter which the user frequently uses.

While this disclosure includes specific embodiments, it will be apparent to one of ordinary skill in the art that various changes in form and details may be made in these embodiments without departing from the spirit and scope of claims and their equivalents.

The embodiments described herein are to be considered in a descriptive sense only, and not for purposes of limitation. Further, it is to be understood that the aspects and advantages of the present disclosure may be embodied by the means and a combination thereof in claims.

A method for editing an image according to an embodiment of the present disclosure includes processing an image through filter application by at least one of a user or a deep neural network trained to perform learning related to filter application, storing filter information related to the filter application collected through a plurality of tests, retraining the deep neural network model so as to learn a filter application pattern according to features of the image using a training data set including the filter information, and outputting filter pattern information based on the filter application pattern by using the deep neural network model.

The processing an image may include processing the image based on first filter information inferred through the deep neural network model, and post-processing the image based on second filter information based on filter selections of the user.

In addition, the method for editing an image may further include training the deep neural network model through learning related to filter application based on features of the image extracted through image analysis.

The filter information may include at least one of information on a function of the filter to process the image, information on a sequence of the filter application, or information on a parameter value of the filter.

The processing the image based on first filter information may include extracting features of the image related to the function of the filter to process the image, extracting the first filter information for processing the image, based on the features of the image, and processing the image based on the first filter information.

The storing filter information may include storing the filter information in association with the features of the image collected through image analysis.

The retraining a deep neural network model may include applying, to a filter, a weighted value proportional to the number of times that the corresponding filter is applied, based on the filter information.

The retraining a deep neural network model may include analyzing the filter information according to the features of the image, and classifying the filter application patterns according to the features of the image based on the analysis.

The filter application pattern according to the features of the image may include at least one of a pattern according to camera type, a pattern according to image color, a pattern according to image subject, a pattern according to image size, or a pattern according to photographing mode.

In addition, the method may further include outputting a target image which is edited by using the filter pattern information.

An apparatus for editing an image according to another embodiment of the present disclosure includes a deep neural network configured to infer filter information for application of an image editing filter, through the image editing filter and learning, a processor configured to process an image by using at least one of the image editing filter or the deep neural network, and a memory configured to store filter information related to the filter application collected through a plurality of tests. The processor retrains a deep neural network model so as to learn a filter application pattern according to features of the image, by using a training data set including the filter information, and outputs filter pattern information based on the filter application pattern by using the deep neural network model.

According to embodiments of the present disclosure, filters that a user frequently uses may be recommended according to the features of an image.

The image may be edited according to an extracted filter application pattern based on filter information related to filters that have been initially applied.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements, in which:

FIG. 1 is a diagram illustrating a deep neural network model according to an exemplary embodiment of the present disclosure;

FIG. 2 is a diagram illustrating a deep neural network model according to an exemplary embodiment of the present disclosure;

FIG. 3 is a diagram illustrating a network environment to which an apparatus for editing an image is connected according to an exemplary embodiment of the present disclosure;

FIG. 4 is a block diagram illustrating an apparatus for editing an image according to an exemplary embodiment of the present disclosure;

FIG. 5 is a block diagram illustrating a learning device according to an exemplary embodiment of the present disclosure; and

FIG. 6 is a flow diagram illustrating a method for editing an image according to an exemplary embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used therein, the terms “module” and “unit” used to refer to components are used interchangeably in consideration of convenience of explanation, and thus, the terms per se should not be considered as having different meanings or functions. In the following description of the embodiments of the present disclosure, a detailed description of the related arts will be omitted when it is determined that the gist of the embodiments disclosed herein may be obscure. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

Although the terms first, second, third, and the like may be used herein to describe various elements, components, regions, layers, and/or sections, these elements, components, regions, layers, and/or sections should not be limited by these terms. These terms are generally only used to distinguish one element from another.

When an element or layer is referred to as being “on.” “engaged to,” “connected to.” or “coupled to” another element or layer, it may be directly on, engaged, connected, or coupled to the other element or layer, or intervening elements or layers may be present. In contrast, when an element is referred to as being “directly on,” “directly engaged to.” “directly connected to,” or “directly coupled to” another element or layer, there may be no intervening elements or layers present.

An image photographed by a digital camera is generally edited by using retouch programs such as various graphic tools. A user can edit an image by using the graphic tools including various menus to adjust brightness and contrast, improve the clarity, control colors, and edit the size. The quality of an image is determined by the skill level of the user who uses the graphic tools.

The editing method using the graphic tools has shortcomings in that editing techniques acquired from much time and experience are required, such as image analysis and filter application techniques. Even in the case of experts, the editing of one image requires a lot of time.

In order to save much time in image editing, and exhibit expert level editing skills, a trained artificial intelligence model can be used. The artificial intelligence model, which is trained through learning of image analysis and filter application based thereon, can analyze an inputted image and extract filter information to be applied to the inputted image. That is, even without an expert's editing skills, the filter information required to edit the inputted image can be extracted by using an artificial model such as a deep neural network trained through learning of filter application.

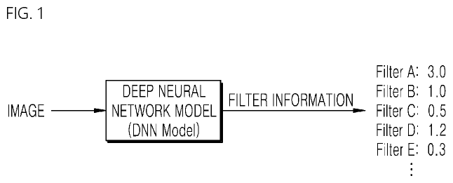

FIG. 1 is a diagram illustrating a deep neural network model according to an exemplary embodiment of the present disclosure.

Referring to FIG. 1, a process of inferring filter information related to a filter applied to an image, performed by a deep neural network model trained through learning of image analysis and filter application based thereon, is shown. The deep neural network model can analyze pixels of the inputted image and extract filter information to be applied to the image based on the analysis result.

A method of training the deep neural network model may include performing training using, as a training data set, an input image from before editing and an output image from after the editing. The deep neural network model can perform image editing training through learning related to analyzing a difference between a pixel value of the image from before editing and a pixel value of the image from after the editing, and reducing the difference between the pixel values of both images through application of various filters.

The deep neural network model trained through this learning process can analyze an image by performing a learning process with respect to a test image, and infer a filter value required for editing the image based on the image analysis, such as a filter value for a type of filter, that is, a function of the filter, and a parameter value of the corresponding filter.

Even when many images photographed by a digital camera are edited based on first filter information extracted through the deep neural network model, a user can post-edit the image based on second filter information so as to acquire the image in a quality suitable for the user's taste. A regular pattern may emerge regarding the type of image filter and the parameter values thereof that are applied in the processes of the editing using the deep neural network model and the post-editing directly performed by the user.

The training data set that was used to train the deep neural network model that inferred the first filter information is unlikely to include an image directly photographed by the user. The deep neural network model stored in a mobile terminal including a digital camera or a camera module is initially trained using a training data set involving big data, and is thus not trained using an optimal method for editing an image directly photographed by a user.

Accordingly, in order to process an image directly photographed by a user, the deep neural network model may, through retraining based on the inferred first filter information, infer filter information which enables the user to edit an image photographed by the user in a manner suitable for the user's taste. Second filter information used in post-editing based on the user's direct filter selection may be included in the initial filter information.

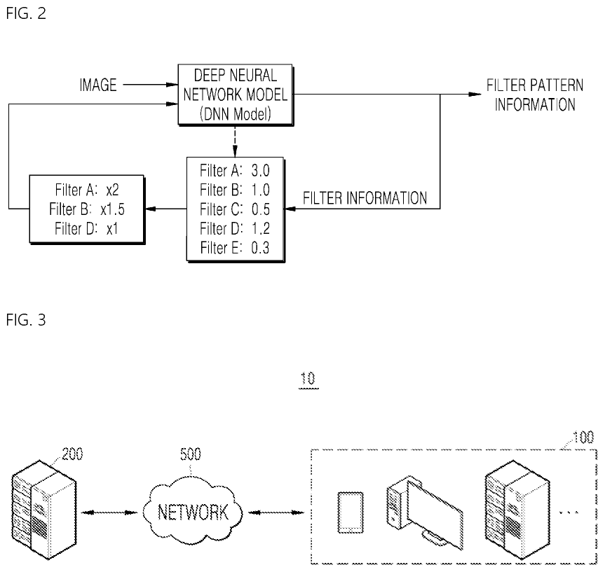

FIG. 2 is a diagram illustrating a deep neural network model according to an exemplary embodiment of the present disclosure.

Referring to FIG. 2, the diagram shows a process in which the trained deep neural network model of FIG. 1 is retrained using a first edit result. The deep neural network model may receive retraining for learning of filter application patterns using a training data set which includes filter information consisting of the first filter information and the second filter information collected through a test process. The deep neural network model in the retraining process may apply a weighted value to a corresponding filter according to the features of the image by using the filter information.

FIG. 3 is a diagram illustrating a network environment to which an apparatus for editing an image is connected according to an exemplary embodiment of the present disclosure.

Referring to FIG. 3, the diagram illustrates a network environment 10 that includes an image editing device 100, a learning device 200, and a network 500 which connects them to each other so as to communicate with each other.

The image editing device 100 according to an embodiment of the present disclosure may be implemented as a mobile terminal corresponding to a digital camera or a smart phone. As a result, the image editing device 100 may be represented by a terminal in some cases. Hereinafter, the image editing device 100 according to an embodiment of the present invention will be described as a mobile terminal, among various examples of the image editing device 100. In the absence of other specific assumptions or conditions, the disclosure of the mobile image editing device 100 may be applied as is to other embodiments.

Artificial intelligence (AI) is an area of computer engineering science and information technology that studies methods to make computers mimic intelligent human behaviors such as reasoning, learning, self-improving, and the like.

In addition, the artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

Specifically, machine learning may be a technology for researching and constructing a system for learning, predicting, and improving its own performance based on empirical data and an algorithm for the same. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modeled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms “artificial neural network” and “neural network” may be used interchangeably herein.

An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

A general single-layer neural network is composed of an input layer and an output layer.

In addition, a general multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer may be the most representative type of artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data may classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms of an ANN may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be input to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is a machine learning method that makes use of both labeled training data and unlabeled training data.

One semi-supervised learning technique involves inferring the label of unlabeled training data, and then using this inferred label for learning. This technique may be used advantageously when the cost associated with the labeling process is high.

Reinforcement learning is based on a theory that given the condition under which a reinforcement learning agent may determine what action to choose at each time instance, the agent may find an optimal path to a solution solely based on experience without reference to data.

Reinforcement learning may be performed mainly through a Markov decision process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-latch size, iteration number, learning rate, and so forth. Furthermore, the model parameters may include a weight between nodes a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size. In SGD, a momentum and Nesterov accelerate gradient (NAG) are methods for increasing optimization accuracy by adjusting a step direction. Adam may include a method that combines momentum and RMSProp and increases optimization accuracy in SGD by adjusting the step size and step direction. Nada may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

Furthermore, the image editing device 100 may retrain the artificial intelligence model that was trained by the learning device 200, using personal data of a user on the basis of a transfer learning method. During a process of retraining or executing the artificial intelligence model, the image editing device 100 may use various artificial intelligence application programs provided by the learning device 200.

An object recognizing method based on deep learning according to an embodiment of the present disclosure may largely include two methods. According to one of the methods, a deep learning model is newly trained, and according to the other method, a pre-trained deep learning model is used.

Initial training of a deep learning model, that is, training of a deep neural network, requires a process of learning features and completing a model by collecting a large amount of labeled training data sets and designing a network architecture. Excellent results can be obtained through training of a deep neural network, but this approach requires vast training data sets and setting of layers and weights in the network used, for example, a CNN.

A plurality of deep learning application programs used in a pre-trained deep learning model may use transfer learning, which is a process including a method of finely adjusting a pre-trained model. According to this transfer learning method, new data including a class not known in the related art may be injected into a deep neural network by using an existing network such as AlexNet or GoogLeNet.

According to the transfer learning, the time consumed may be reduced and the output may be rapidly calculated, due to the previous training of the model with thousands or millions of images.

Although the deep learning model provides a high level of precision in image analysis, for accurate image analysis, a large amount of training data sets, that is, learning images which photograph a number of subjects, is required.

The image editing device 100 according to an embodiment of the present disclosure, which is one deep learning model, may analyze a photographed image, extract features of the image, and use a CNN model trained by using the extracted features. The CNN may analyze features of the image by using the extracted features, and thereby extract filter information to be applied to edit the image.

Image analysis based on machine learning may include manually extracting features and analyzing the extracted features. For example, a HOG feature extraction method using a support vector machine (SVM) learning algorithm may be used in an exemplary embodiment of the present disclosure. Other feature extraction algorithms, such as Harris corner. Shi & Tomasi, SIFT-DoG, FAST, AGAST, and major invariant feature (SURF, BRIEF, ORB) methods, may be used.

The learning device 200 trains the artificial intelligence model according to an embodiment of the present invention, that is, the deep neural network model, through learning. The learning device 200 will be described below.

The network 500 may be an appropriate communication network including wired and wireless networks, such as a local area network (LAN), a wide area network (WAN), the Internet, the Intranet, and the extranet and a mobile network such as cellular, 3G. LTE, 5G, a Wi-Fi network, and AD hoc network, and a combination thereof.

The network 500 may include connection of network elements such as hubs, bridges, routers, switches, and gateways. The network 500 may include one or more connected networks, including a public network such as the Internet and a private network such as a secure corporate private network. For example, the network may include a multi-network environment. The access to the network 500 may be provided via one or more wired or wireless access networks.

The image editing device 100 may transmit and receive data with the learning device 200 through a 5G network. Specifically, the image editing device 100 implemented by a smart phone may perform data communication with the learning device 200 using at least one service of enhanced mobile broadband (eMBB), ultra-reliable and low latency communications (URLLC), or massive machine-type communications (mMTC), through the 5G network.

eMBB is a mobile broadband service, and provides, for example, multimedia contents and wireless data access. In addition, more improved mobile services such as a hotspot and a wideband coverage for receiving mobile traffic that are tremendously increasing may be provided through eMBB. Through a hotspot, high-volume traffic may be accommodated in an area where user mobility is low and user density is high. A wide and stable wireless environment and user mobility can be secured by a wideband coverage.

The URLLC service defines requirements that are far more stringent than existing LTE in terms of reliability and transmission delay of data transmission and reception, and corresponds to a 5G service for production process automation in fields such as industrial fields, telemedicine, remote surgery, transportation, safety, and the like.

mMTC is a transmission delay-insensitive service that requires a relatively small amount of data transmission, mMTC enables a much larger number of terminals, such as sensors, than general mobile cellular phones to be simultaneously connected to a wireless access network. In this case, the communication module price of the terminal should be inexpensive, and there is a need for improved power efficiency and power saving technology capable of operating for years without battery replacement or recharging.

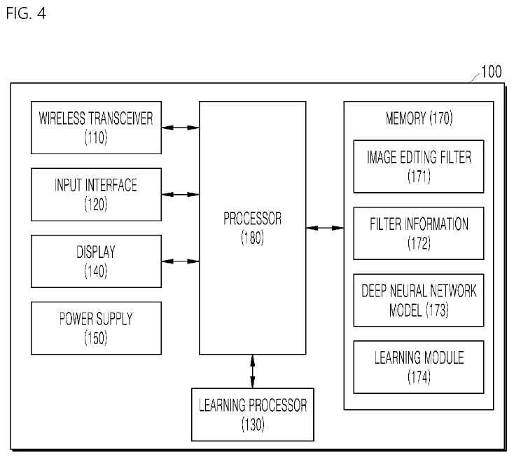

FIG. 4 is a block diagram illustrating an apparatus for editing an image according to an exemplary embodiment of the present disclosure.

Referring to FIG. 4, components of the memory 170 included in the image editing device 100 are schematically illustrated. Various computer program modules may be loaded on the memory 170. The computer program equipped in the memory 170 may include an operating system, and the application programs, excluding the system program which manages hardware, may include an image editing filter 171, filter information 172, a deep neural network model 173, and a learning module 174.

The functions related to the image editing filter 171, such as processing a pixel for constituting an image, adjusting brightness and contrast, controlling colors, removing noise, and regulating white balance may be performed through various arithmetic functions of a processor 180.

The functions related to the filter information 172, such as collecting filter information applied to the image, constituting a database based on the collected filter information, and managing the constituted database, may be performed through various arithmetic functions of the processor 180.

The functions related to the deep neural network model 173, such as analyzing the image, extracting features of the image, and extracting the filter information using a neural network based on machine learning or deep learning, may be performed through various arithmetic functions of the processor 180.

A function of training and retraining a neural network based on machine learning or deep learning related to the learning model 174 may be performed by various computing functions of the processor 180.

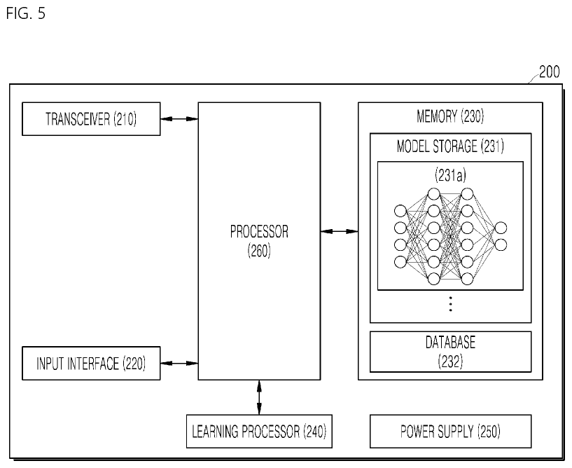

FIG. 5 is a block diagram illustrating a learning device according to an exemplary embodiment of the present disclosure.

The learning device 200 is a device or a server which is separately configured at the outside of the image editing device 100, and may perform the same function as the learning processor 130 of the terminal 100.

That is, the learning device 200 may be configured to receive classify, store, and output information to be used for data mining, data analysis, intelligent decision making, and machine learning algorithms. Here, the machine learning algorithm may include a deep learning algorithm.

The learning device 200 may communicate with at least one image editing device 100, and derive a result by analyzing or learning the data on behalf of the image editing device 100. Here, “on behalf of” another device may refer to distribution of computing power by means of distributed processing.

The learning device 200 of the artificial neural network, which refers to various devices for learning an artificial neural network, may normally refer to a server, may also be referred to as a learning device or a learning server.

Specifically, the learning device 200 may be implemented not only as a single server, but also as a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by machine learning or deep learning to the image editing device 100 periodically or upon request.

Referring to FIG. 5, the learning device 200 may include a transceiver 210, an input interface 220, a memory 230, a learning processor 240, a power supply 250, a processor 260, and so forth.

The transceiver 210 may correspond to a configuration including the wireless transceiver 110 and the I/O connector 160 of FIG. 4. That is, the transceiver may transmit and receive data with the other device through wired/wireless communication or an interface.

The input interface 220 is a configuration corresponding to the input interface 120 of FIG. 4, and may receive the data through the transceiver 210 to obtain data.

The input interface 220 may obtain input data for acquiring an output, using training data for model learning and a trained model.

The input interface 220 may obtain unprocessed input data, and in this case, the processor 260 may pre-process the obtained data to generate training data or pre-processed input data that can be inputted in the model learning.

In this case, the pre-processing of the input data performed by the input interface 220 may refer to extracting of an input feature from the input data.

The memory 230 is a configuration corresponding to the memory 170 of FIG. 4.

The memory 230 may include, for example, a storage memory 231 and a database 232.

The model storage 231 stores a model (or an artificial neural network 231a) which is learning or trained through the learning processor 240 and when the model is updated through the learning, stores the updated model.

If necessary, the storage memory 231 may store the trained model by dividing the model into a plurality of versions depending on a training timing or a training progress.

The artificial neural network 231a illustrated in FIG. 5 is one example of artificial neural networks including a plurality of hidden layers but the artificial neural network of the present disclosure is not limited thereto.

The artificial neural network 231a may be implemented as hardware, software, or a combination of hardware and software. When a part or the entire artificial neural network 231a is implemented by software, one or more commands which configure the artificial neural network 231a may be stored in the memory 230.

The database 232 stores input data obtained from the input interface 220, learning data (or training data) used to learn a model, a learning history of the model, and so forth.

The input data stored in the database 232 may not only be data which is processed to be suitable for the model learning, but may also itself be unprocessed input data.

The learning processor 240 is a configuration corresponding to the learning processor 130 of FIG. 1.

The learning processor 240 may train the artificial neural network 231a using the training data or a training set.

The learning processor 240 may immediately obtain data which is obtained by pre-processing input data obtained by the processor 260 through the input interface 220 to train the artificial neural network 231a, or obtain the pre-processed input data stored in the database 232 to train the artificial neural network 231a.

Specifically, the learning processor 240 repeatedly may train the artificial neural network 231a using various learning techniques described above to determine optimized model parameters of the artificial neural network 231a.

In this specification, the artificial neural network which is trained using training data to determine parameters may be referred to as a learning model or a trained model.

Here, the trained model may infer result values even while being installed in a learning device 200 of an artificial neural net and may be transferred to and installed in another device such as the image editing device 100 by a transceiver 210.

Further, when the learning model is updated, the updated learning model may be transmitted to the other device such as the image editing device 100 via the transceiver 210 to be loaded.

The power supply 250 is a configuration corresponding to the power supply 190 of FIG. 4.

Redundant description of corresponding configurations will be omitted.

In addition, the learning device 200 may evaluate the artificial neural network 231a and update the artificial neural network 231a for better performance after evaluation, and provide the image editing device 100 with the updated artificial neural network 231a. Here, the image editing device 100 may perform a series of steps performed by the learning device 200 solely in a local area, or together with the learning device 200 through communication with the learning device 200. For example, the image editing device 100 may update the deep neural network model 173 downloaded from the learning device 200 by causing the deep neural network model 173 of the local area to learn a personal pattern of the user, through retraining using the personal data of the user.

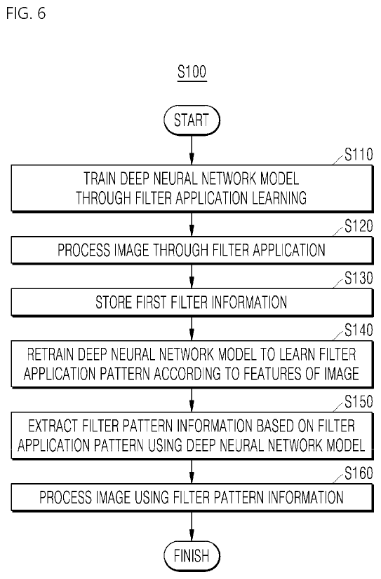

FIG. 6 is a flow diagram illustrating a method for editing an image according to an exemplary embodiment of the present disclosure.

Referring to FIG. 6, the method for editing an image (S100) may include training a deep neural network model through filter application learning (S110), editing an image through filter application (S120), storing filter information (S130), retraining the deep neural network model to learn a filter application pattern according to features of the image (S140), extracting a second filter information based on the filter application pattern using the deep neural network model (S150), and processing the image based on the second filter information (S160).

Each step constituting the method for editing an image (S100) may be performed through various program module controls equipped in a memory of the processor 180 included in the image editing device 100 according to an embodiment of the present invention. Hereinafter, each step of the method for editing an image (S100) performed by the processor 180 will be described.

Regardless of any difference between the meanings of the terms “applying filters”, “image processing”, “filtering”, “editing”, and “retouching” as used in the present disclosure and their original meanings, these terms are used herein to include the general idea of editing an image using a filter for editing an image. Further, when “image editing” is taken to mean changing a pixel value of pixels which constitute an image, image editing may include processes such as distortion correction, noise removal, brightness adjustment, color control, contrast regulation, and clarity emphasis.

The method for editing an image (S100) may include training the deep neural network model through learning related to filter application based on the extracted features of the image by image analysis (S110). The learning related to the filter application performed in the process of designing the deep neural network model may be referred to as initial learning.

The process of training the deep neural network model through designing and learning of the deep neural network model may be performed by the learning device 200. Further, the learning device 200 may function as the image editing device 100. A user terminal such as a smart phone may be directly involved in the training of the deep neural network model through learning, but a deep neural network model trained mainly through the learning device 200 may also be used.

The processor 180 may process the image through filter application by at least one of a user or a deep neural network model trained to perform learning related to filter application (S120). That is, the filter information used to process the image may be extracted through image analysis by a user or by the deep neural network model, that is, the artificial intelligence algorithm. Further, the image subject to be processed may be processed by using both of the above, that is, the image may be pre-processed using the artificial intelligence algorithm and post-processed using a filter selected by a user.

As a result, the processing the image (S120) may include image processing using first filter information inferred through the deep neural network model, and image processing using second filter information based on a user's filter selection. The filter information used to process the image may include the first filter information and the second filter information.

The above filter information may include at least one of information on a function of the filter to process the image, information on a sequence of applying the filter, or information on a parameter value of the filter. The functions of the filter include distortion correction, noise removal, brightness adjustment, color control, contrast regulation, and clarity emphasis, and the filter may be named according to its corresponding function.

The image processing using the first filter information may include extracting features of the image related to the function of the filter to process the image, extracting the first filter information in order to process the image based on the features of the image, and processing the image based on the first filter information. The deep neural network model used herein may be designed based on a convolutional neural network (CNN), which is widely used in image processing. Depending on the type of learning, the CNN may directly extract features from the image, or the features of the image may be extracted using algorithm.

The features of the image used in the present disclosure may indicate feature vectors extracted from the image. These feature vectors may include information on pixel values which constitute the image, for example, information on an object included in the image, brightness of the image, and noise and colors of the image.

The image processing using the first filter information may include extracting features of the image related to the function of the filter to process the image, extracting the first filter information in order to process the image based on the features of the image, and processing the image based on the first filter information.

The process of analyzing the image by extracting the features of the image and extracting the filter information to be applied in the image processing by using the analysis result will be described as follows by way of example. The CNN, which is one deep neural network model, prepares a feature map of an image inputted through a convolutional algorithm using a filter (distinguished from the filter to process the image). Since the feature map includes information on pixels of the image, through the feature map, brightness of the image may be predicted, and parameter values of a brightness adjustment filter for changing the brightness of pixels in the entire area or a partial area of the image may be predicted. The first filter information may include locations of the pixels to be processed and parameter values of the brightness adjustment filter.

Related to the color correction, in order to correct the skin tone of a human, the CNN may prepare a feature map by using the features of the image, and recognize a human facial region based on the feature map. The CNN may determine how light the skin tone is through information on the pixel values of the face region, and output the filter information on the color correction filter to correct the skin tone.

The deep neural network model outputs the filter information based on the features of the image, and a user can pre-edit the image based on the outputted filter information, that is, the first filter information. According to the user's decision, the user can select a filter for the preferred typed editing and designate a parameter value of the filter, and thereby post-edit the pre-edited image. Here, the second filter information may include a filter selected by the user and a parameter value of the filter. Further, the filter information, constituted by the first filter information and the second filter information that are applied to many test images, may be used as learning data in retraining the deep neural network model thereafter.

The processor 180 may store the filter information related to the filter application collected through a plurality of tests (S130). That is, the processor 180 may collect and store the filter information including the first filter information and the second information collected from the image editing device 100, that is, the edge end.

Further, the processor 180 may store the filter information in association with the features of the image collected through image analysis. Through this process, it is possible to analyze which filter application pattern is formed according to the features of the image.

If the first filter information, which is helpful in processing the image according to the features of the image such as brightness and contrast and colors of the image, is extracted through training by the first learning of the deep neural network model, the filter application pattern may be obtained based on the first filter information through retraining by the second learning of the deep neural network model. The processor 180 may retrain the deep neural network model so as to learn the filter application pattern according to the features of the image using the training data set including the filter information (S140). The first filter information extracted using the deep neural network model after the first learning and the second filter information applied by the user's selection may be used as data for learning in the retraining of the deep neural network model.

The retraining of the deep neural network model may include analyzing the filter information according to the features of the image, and classifying filter application patterns according to the features of the image based on the filter information analysis.

The deep neural network model may classify the filter application patterns according to the features of the image using the filter information stored in association with the features of the image. For example, based on filter information which is mainly used in images of people and filter information which is mainly used in landscape photographs, the filter application patterns may be classified into a filter application pattern for photographs of people and a filter application pattern for landscape photographs. Since these filter application patterns are dependent not only upon the first filter information but also the second filter information, the user's preferences may be reflected in the filter application patterns.

The filter application patterns according to the features of the image according to an embodiment of the present disclosure may include at least one of a pattern according to camera type, a pattern according to image color, a pattern according to image subject, a pattern according to image size, or a pattern according to photographing mode. When the image editing device 100 is a mobile terminal such as a smart phone, a pattern according to the mobile terminal type or according to name of the camera module included in mobile terminal may be formed.

If the sky or the sea is included in a subject, a filter application pattern for an image in which a blue color is dominant may be formed. Moreover, according to the subject of the image, such as a forest, a snowy landscape, the sea, and people, a filter application pattern for an image related to the corresponding subject may be formed. During the retraining process, the processor 180 may apply, to a filter, a weighted value proportional to the number of times that the filter is applied, based on the filter information. The deep neural network model may reduce the value of a loss function by adjusting the weighted value in the learning process, and the retraining process may be shortened as the weighted value is applied in the retraining process based on the first filter information and the second filter information. Referring to FIG. 2, the filter information collected through the test process is used in the retraining of the deep neural network model, and using the filter information according to the features of the image, the deep neural network may extract the filter application patterns, that is, filter pattern information. FIG. 2 illustrates the process in which a weighted value of 2 times is applied to Filter A, a weighted value of 1.5 times is applied to Filter B, and weighted value of 1 time is applied to Filter D.

The processor 180 may output the filter pattern information based on filter application patterns using the deep neural network model (S150). If the deep neural network model after the initial training extracted the first filter information based on the features of the image, the deep neural network model after the retraining may analyze the filter application patterns according to the features of the image based on the first filter information and the second filter information based on the user's selection, and extract the filter pattern information through the analysis result. The filter pattern information, like the filter information, may include at least one of information on a function of a filter, information on a sequence of applying the filter, or information on a parameter value of the filter. The filter pattern information may further include filter information according to the user's preference compared to the filter information, and filter information which is optimized according to the features of the image.

The processor 180 may process the image using the filter pattern information. Finally, the processor 180 may process the image so as to be suitable for the user's preference, using the filter pattern information based on the filter application pattern extracted through the retraining of the deep neural network model.

As mentioned above, according to embodiments of the present disclosure, filters that a user frequently uses may be recommended according to the features of an image.

Further, the image may be edited according to filter application patterns extracted based on filter information related to filters that have been initially applied.

The above-described embodiments of the present disclosure may be implemented in the form of a computer program which can be executed by various components on a computer and the computer program may be recorded in computer readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code included both machine codes, such as produced by a complier, and higher level code that may be executed by the computer using an interpreter.

The singular forms “a,” “an” and “the” in this present disclosure, in particular, claims, may by intended to include the plural forms as well. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” etc.) used herein merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations may be made depending on design conditions and factors within the scope of the appended claims or equivalents thereof.

What is claimed is:

1. A method for editing an image, the method comprising:
processing an image through filter application by at least one of a user or a deep neural network trained to perform learning related to filter application;
storing filter information related to the filter application collected through a plurality of tests;
retraining the deep neural network model so as to learn a filter application pattern according to features of the image using a training data set including the filter information; and
outputting filter pattern information based on the filter application pattern by using the deep neural network model.

2. The method according to claim 1, wherein the processing an image comprises:
processing the image based on first filter information inferred through the deep neural network model; and
post-processing the image based on second filter information based on filter selections of the user.

3. The method according to claim 2, further comprising training the deep neural network model through learning related to filter application based on features of the image extracted through image analysis.

4. The method according to claim 1, wherein the filter information comprises at least one of information on a function of the filter to process the image, information on a sequence of the filter application, or information on a parameter value of the filter.

5. The method according to claim 2, wherein the processing the image based on a first filter information comprises:
extracting features of the image related to the function of the filter to process the image;
extracting the first filter information for processing the image, based on the features of the image; and
processing the image based on the first filter information.

6. The method according to claim 1, wherein the storing filter information comprises storing the filter information in association with the features of the image collected through image analysis.

7. The method according to claim 1, wherein the retraining a deep neural network model comprises applying, to a filter, a weighted value proportional to the number of times that the corresponding filter is applied, based on the filter information.

8. The method according to claim 1, wherein the retraining a deep neural network model comprises:
analyzing the filter information according to the features of the image; and
classifying the filter application patterns according to the features of the image based on the analysis.

9. The method according to claim 1, wherein the filter application pattern according to the features of the image comprises at least one of a pattern according to camera type, a pattern according to image color, a pattern according to image subject, a pattern according to image size, or a pattern according to photographing mode.

10. The method according to claim 1, further comprising outputting a target image which is edited by using the filter pattern information.

11. An apparatus for editing an image, the apparatus comprising:
a deep neural network configured to infer filter information for application of an image editing filter, through the image editing filter and learning;
a processor configured to process an image by using at least one of the image editing filter or the deep neural network; and
a memory configured to store filter information related to the filter application collected through a plurality of tests,
wherein the processor is configured to retrain a deep neural network model to learn a filter application pattern according to features of the image by using a training data set including the filter information, and output filter pattern information based on the filter application pattern by using the deep neural network model.

12. The apparatus according to claim 11, wherein the processor is configured to process the image by using at least one of first filter information inferred through the deep neural network model or second filter information based on filter selections of a user.

13. The apparatus according to claim 12, wherein the deep neural network is trained through learning related to the filter application based on the features of the image extracted through image analysis.

14. The apparatus according to claim 11, wherein the filter information comprises at least one of information on a function of the filter to process the image, information on a sequence of the filter application, or information on a parameter value of the filter.

15. The apparatus according to claim 12, wherein the processor is configured to extract features of the image related to the function of the tilter to process the image, and collect the first filter information for processing the image based on the features of the image.

16. The apparatus according to claim 11, wherein the processor is configured to control the memory to store the filter information in association with information on the features of the image collected through image analysis.

17. The apparatus according to claim 11, wherein the processor is configured to apply, to a filter, a weighted value proportional to the number of times that the corresponding filter is applied, based on the filter information.

18. The apparatus according to claim 11, wherein the processor is configured to analyze the filter information according to the features of the image, and train the deep neural network to classify the filter application patterns according to the features of the image based on the analysis.

19. The apparatus according to claim 11, wherein the filter application pattern according to the features of the image comprises at least one of a pattern according to camera type, a pattern according to image color, a pattern according to image subject, a pattern according to image size, or a pattern according to photographing mode.

20. The apparatus according to claim 11, wherein the processor is configured to output a target image which is edited by using the filter pattern information.
